(19) United States
(12) Patent Application Publication
(10) Pub. No.: US 2021/0360743 A1
(43) Pub. Date: Nov. 18, 2021

(54) PTC Heating Cell and Method for Manufacturing the Same

(71) Applicant: Eberspächer catem Hermsdorf GmbH & Co. KG, Hermsdorf (DE)

(72) Inventors: Florian Bitto-Golon, Remse (DE); Alfred Blüml, Grunwald (DE); Yves Knüpfer, Caaschwitz (DE); Andreas Kümpel, Wunschendorf/Elster (DE)

(21) Appl. No.: 17/319,264

(22) Filed: May 13, 2021

(30) Foreign Application Priority Data
May 14, 2020 (DE) 10 2020 113 124.0

(51) Int. Cl. H05B 3/06; B23K 1/002

(52) U.S. Cl. CPC H05B 3/06; B23K 1/002; B23K 2101/36; H05B 2203/016; H05B 2203/017; H05B 2203/02

(57) ABSTRACT

A method is provided for manufacturing a PTC heating cell with at least one PTC element and contact elements which are made of an electrically conductive material, which are electrically conductively abutted against the PTC element, and which are connected to the PTC element and a corresponding heating cell. In order to improve heat extraction and the connection between the contact element and the PTC element, the contact elements are connected to the PTC element by induction soldering. Also disclosed is a PTC cell in which there is only solder of the solder connection between the thermistor material of the PTC element and the contact element.

### BACKGROUND OF THE INVENTION

### 1. Field of the Invention

The present invention relates to a PTC heating cell. Such a PTC heating cell has at least one PTC element and contact elements made of an electrically conductive material which are electrically conductively abutted thereto and connected to the PTC element.

### 2. Background of the Invention

Such a PTC heating cell is generally known. The present invention relates in particular to a PTC heating cell used in a motor vehicle.

The contact element serves to introduce the power current into the PTC element. The PTC element usually consists of a PTC thermistor material. This PTC material consists of semiconducting ceramic particles. The ceramic particles are sintered for generating the PTC element. The PTC element can be disc-shaped or cuboid-shaped. In the implementations under consideration here, the PTC element is typically formed as a thin cuboid with opposing main side surfaces that are substantially larger than the end side surfaces connecting these two main side surfaces.

Those surfaces of the ceramic PTC element, which serve to introduce the power current, are usually provided with a metallization. This metallization is applied as a layer to the ceramic material, for example sputtered or vapor-deposited. In addition to the ceramic material, the commercially available PTC element, which is usually used in heating assemblies, also typically comprises the corresponding metallization on opposing surfaces for the introduction of current.

The contact elements are applied to these metallized surfaces of the PTC element. For this purpose, there are various possibilities. Thus, it is possible to glue the contact elements to the PTC element. The adhesive can be an electrically conductive adhesive. It can also be electrically non-conductive in itself and be provided with electrically conductive particles that conduct the current from the contact element to the metallization. It is also possible to solder the contact elements to the PTC element. In this case, the contact element is deposited on the PTC element, specifically the metallization provided thereon. The solder is applied to this metallization and to the surfaces of the contact element to connect the contact elements to the PTC element with a material bond.

The ceramic material of the sintered PTC element is relatively brittle. Thus, the PTC element must be subjected to gentle mechanical stress both during manufacture, thus, within the framework of the connection of the PTC element and the contact element, and also during use in an electric heating device.

In addition, the PTC element is a thermistor. These thermistors are used in particular in the field of automotive engineering, since their electrical resistance increases with rising temperature. Above the Curie temperature, the lack of polarization within the ceramic component results in an insulating effect so that the electrical resistance increases exponentially due to the PTC element. This self-regulating effect of the PTC elements is indeed positive when it is important to avoid overheating of the PTC element and thus of the heating assembly. On the other hand, poor heat extraction from the PTC element has a negative effect on efficiency. Thus, the actual installed heat output cannot be obtained.

In view of this, those skilled in the art are seeking to keep heat resistances between the ceramic material of the PTC element and the outside of a heating cell or an electric heating device for utilizing the heat of a PTC element as low as possible.

These considerations are also based on an earlier proposal to apply an adhesive, which is improved in terms of its heat conductivity by electrically non-conductive ceramic particles, between the contact element and the metallization and to partially displace the same so that the roughness peaks of the metallization cause the electrical contacting, whereas the gap filled by the adhesive has relatively good heat conductivity.

Despite the efforts of those skilled in the art, there are still opportunities for improvement.

### SUMMARY

The present invention aims to provide a method for manufacturing a PTC heating cell which can be carried out with little effort and results in little impairment of the heat conduction path from the PTC element to the outer surface of the heating cell. The PTC heating cell according to the invention is also intended to have such an improved heat conduction path.

In order to solve the problem according to the method, the present invention proposes to connect the contact elements to the PTC element by means of induction soldering.

In the method according to the invention, the contact element is connected to the sintered ceramic material of the PTC element by a material bond. Solder is located between the contact element and the PTC element. This solder is melted by induction soldering. Two variants are conceivable here.

In a first variant, the solder is located between the metallization and the contact element. In this variant, the contact element is soldered onto the metallization of the PTC element by means of induction soldering in a manner known. In an alternative configuration, which also reflects the gist of the invention according to the device, there is only the solder of the solder connection between the contact element and the surface of the thermistor material of the PTC element. This solder of the solder connection is melted and connects the contact element to the ceramic material. The solder can be the melted material of the metallization layer on the surface of the ceramic material. In this context, the PTC element can be manufactured and prepared in a manner known. Accordingly, before the contact elements are joined to the PTC element, it has a metallization on its surface intended for the introduction of the power current. Within the induction soldering process, this metallization is melted and joined to the contact element. Alternatively, the PTC element can be provided without a metallization on one of the surfaces. This metallization is only created during the induction soldering process.

The procedure during induction soldering allows any type of temperature control, as long as it is below the melting point of the contact element. These contact elements are usually made of metal, typically a stamped metal sheet, which is applied at least partially to a surface of the PTC element and connected thereto. The metal sheet usually also forms contact lugs in one piece, projecting beyond the ceramic material, for the plug-in contacting of the PTC heating cell.

Induction soldering results in an overall and thus good heat-conducting connection between the contact element and the PTC element. This improves the heat conduction path. Heat conduction resistances to the outside of the PTC heating cell are reduced. The contacting of the contact element can also be carried out, for example, on a main side surface of the PTC element without significantly impairing the heat conduction path.

In contrast to solutions in which the contact element is connected to the PTC element by means of adhesive, a firm connection between the contact element and the PTC element results immediately after soldering. Curing and setting times do not have to be observed. The contact element can be of any shape, since induction soldering permits defined local treatment at the soldering point and the phase boundary between the contact element and the PTC element.

Induction soldering can be carried out such that a contact element is applied to the surface of the PTC element, if necessary after a certain period of preheating to reduce the soldering time. The joint is then heated by induction heating such that the solder located at the joint heats up and liquefies. In this context, capillary forces can draw the solder between the surface of the contact element and the PTC element and thus concentrate solder at the phase boundary between the two connection partners of the solder connection. This applies in particular to a possible metallization. Induction soldering can be carried out such that the inductively generated heat not only heats the contact element, but also a metallization on the surface of the sintered ceramic particles.

Alternatively, the contact element can first be heated and then the contact element can be applied to the PTC element and soldered to it. In this process, solder can be applied beforehand to the contact element and/or to the associated mating surface of the PTC element, which melts onto the surface of the PTC element with or during the application of the strip conductors. In a first variant, for example, the strip conductor is guided through a stationary inductive furnace and heated in this process, and in the heated state is applied to the PTC element outside the furnace. In another variant, the inductive heat source is moved along with the contact element so that it is still heated after being deposited on the PTC element until the soldering process is complete.

The PTC heating cell according to the invention has a PTC element and contact elements connected thereto for energizing the PTC element with the power current. These contact elements are connected to the ceramic thermistor material of the PTC element. The solder connection is a connection made by means of induction soldering. In this context, only the solder of the solder connection is located between the surface of the ceramic material and the surface of the contact element. This solder can be applied during soldering. It can also be the conductive metal of the metallization melted and previously applied to the ceramic material. In any case, there is a lack of two metallic materials applied in succession in the gap between the contact element and the ceramic material, as is the case when a contact element is soldered onto a metallization. The solder between the surface of the ceramic material and the contact element is completely melted and then solidified during induction soldering. This uniform solidification can be seen in the structure of the solder material.

In the PTC heating cell according to the invention, the solder layer created by induction soldering causes a mechanical connection, in particular between the ceramic surface of the PTC element and the contact element, wherein additionally on the microscopic level an electrical conductivity between these two surfaces must be caused. In particular, when the solder layer is applied directly to the ceramic surface of the PTC element, the solder applied by induction soldering creates a barrier layer structure on the surface of the sintered PTC thermistor material, which forms the PTC element, or more precisely, the PTC ceramic without the metallization layer otherwise provided.

The procedure according to the invention can be used both for complete coverage of the PTC element with a contact element and for partial coverage of the surface of the PTC ceramic with the contact element.

### BRIEF DESCRIPTION OF THE DRAWINGS

Further details and advantages of the present invention will become evident from the following description of an embodiment shown in the drawing. Therein:

FIG. 1 shows a perspective side view of an embodiment of a heating cell, and

FIG. 2 shows a side view of the embodiment shown in FIG. 1.

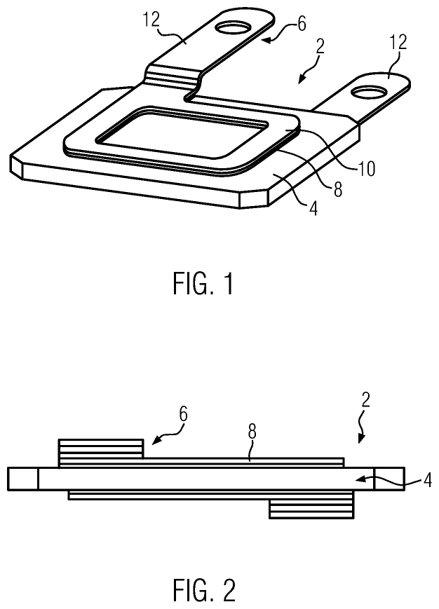

### DETAILED DESCRIPTION

The embodiment shown in the Figures of a heating cell identified by reference sign 2 comprises a PTC ceramic 4. This PTC ceramic 4 is a cuboid-shaped plate made of a sintered thermistor material. There is no metallization applied two-dimensionally to the opposite main side surfaces of the PTC ceramic 4. Thus, the ceramic component forms the PTC element 4 of the present invention.

The contact elements 6, made of a stamped and bent sheet material and deposited on the PTC element 4, are connected to the PTC element 4 via a solder 8. The solder 8 can be seen in FIG. 2 between the contact element 6 and the surface of the PTC element 4. The solder 8 is located exclusively between the contact element 6 and the PTC element 4. The ceramic material itself forms the remaining surfaces of the PTC element 4.

In the embodiment shown, the contact element 6 contacts the PTC element 4 via an annular contact surface. A terminal lug 12 extends from this annular contact surface 10. Both contact elements 6a, 6b have a corresponding terminal lug 12, each of which projects beyond the same end face of the PTC element 4.

1. A method for manufacturing a PTC heating cell with at least one PTC element and contact elements which are made of an electrically conductive material, which are electrically conductively abutted against the PTC element, and which are connected to the PTC element, the method comprising:
providing the contact elements and the PTC element; and
induction soldering the contact elements to the PTC element.

2. The method according to claim 1, wherein the contact elements are deposited directly on a metallization formed on the PTC element, and wherein the metallization is melted during induction soldering to form a positive connection between the contact element and the PTC element.

3. The method according to claim 1, wherein a solder is introduced between the PTC element and the contact elements during the induction soldering.

4. The method according to claim 1, wherein at least one of the contact elements is first applied to the PTC element, and inductive heating is then carried out.

5. The method according to claim 1, wherein at least one of the contact elements is first inductively heated, and then the contact element is applied to the PTC element and soldered thereto.

6. The method according to claim 1, wherein at least one of the contact elements is first inductively heated, and then the contact element is applied to the PTC element and soldered thereto at a phase boundary between the contact elements and the PTC element during continued inductive heating.

7. A PTC heating cell comprising:
at least one PTC element; and
contact elements which are made of an electrically conductive material and which are electrically conductively abutted against the PTC element, wherein the contact elements are soldered to the PTC element such that only solder of the solder connection is provided between a PTC material of the PTC element and the contact element.
